(19) United States
(12) Patent Application Publication
(10) Pub. No.: US 2005/0035331 A1
(43) Pub. Date: Feb. 17, 2005

(54) Phosphorescent blends

(76) Inventor: Xiao-Dong Sun, Fremont, CA (US)

Correspondence Address: CHARLES QIAN, 1018 CRANBERRY DR., CUPERTINO, CA, 95014, US

(21) Appl. No.: 10/874,895

(22) Filed: Jun. 23, 2004

Related U.S. Application Data
(60) Provisional application No. 60/482,326, filed on Jun. 24, 2003.

(51) Int. Cl. F21V 9/16

(52) U.S. Cl. 252/301.5

(57) ABSTRACT

Self-glowing phosphorescent blends comprises of silicates, phosphate, and their compounds with aluminates (e.g. alumino-silicates and alumino-phosphate) phosphors are disclosed. These blends can be optically charged by exposure to sunlight or artificial light sources, and are able to emit visible light for hours in darkness without the need of electricity or consumption of materials. Such optical charging-discharging cycles can be repeated at least 1000 times. These blends can be used to form many commercial products and used in many applications such as: self-glowing paints or coating blends, self-glowing adhesive tapes, self-glowing foils, self-glowing glues and sealants, self-glowing ceramic glazes, self-glowing writing and printing inks, self-glowing papers and stickers, self-glowing textiles and cloth, self-glowing glasses, and self-glowing plastic composites. The “self-glowing” refers to the ability to emit visible light or photon, without simultaneously being externally excited, or consumption of energy (like lamps) or materials (like candle) at the same time. These self-glowing blends or composites can glow in the darkness without consuming electricity and can be utilized in the following applications:
1. Self-glowing marking, labeling, decoration, film coating, and paintings on the body of bicycles, automobiles, ships, and aircrafts. Such utility will display the contour, the location, and color of the subject's body at night or in darkness with the benefits of decoration and safety of traveling.
2. Self-glowing marking, labeling, decoration, film coating, and paintings on the walls, the swimming pools, stairs, steps, and other outstanding objects inside or outside of a building. Beside apparent decoration utility in the darkness, they can also show the contour or locations of the objects in the darkness to avoid injury related liability.
3. Low-level lighting source, i.e. “Electric less” lamps. By applying the blend on artificial lamp surfaces, they can self-glow in the darkness for hours after lamp is turned off. When lamp is back on, they can be optically excited and charged up, while shifting the lamp color to longer wavelength and warmer appearance.
4. The blends can be utilized in many other special self-glowing products to save electricity and pollution and prevent safety hazards in darkness. For example, self-glowing paper and ink will allow people to write in the darkness without need for lamps. Self-glowing paint, tapes, ceramic glaze, and labels will allow people to act in the darkness without the need for electric lamps. Self-glowing glass and plastic articles will decorate or display at night without need for electric lamps. Besides conserving electricity and environment, self-glowing products may be used to direct traffic and prevent injury associated with power outage or electric lamps failure. These products also provide convenient safety measures in products such as self-glowing textiles that pedestrian and bicyclists can wear at night, without the need for electric lamps.

This application claims priority to the provisional application entitled “Phosphorescent Self-Glowing Blends and Their Applications”, Ser. No. 60/482,326, filed by the same subject inventors and assignee as the subject invention on Jun. 24, 2003.

### BACKGROUND OF THE INVENTION

1. Field of the Invention

The present invention relates generally to blends containing self-glowing phosphor and more particularly to the making and use of various forms of such blends in the darkness for visual marking and decoration without consuming electricity or chemicals.

2. Background Art

Currently people are relying on electricity for lighting. That put us in a vulnerable position when, or where there is no electricity (e.g. rural area). It also pollutes the environment since the electricity is generated mostly from burning fossil fuel, and lighting represents the biggest consumption of electricity (˜41%). The old-fashioned lighting with candle consumes material and chemical energy; it is also a “spot” lighting source with very limited brightness and reach. Question arises: Is there any “cleaner” alternative source of lighting technology?

Self-Glowing phosphors are substances that emit light after having absorbed visible or ultraviolet radiation or the like, and the afterglow of the light that can be visually observed continues for a considerable time, ranging from several minutes to several hours after the source of the stimulus is cut off. Until recently, the most commonly known non-radioactive phosphorescent phosphor pigments were sulfides of zinc, calcium, strontium and cadmium, such as CaS:Bi (which emits violet blue light), CaSrS:Bi (which emits blue light), ZnCdS:Cu (which emits yellow or orange light) and ZnS:Cu (which emits green light). The color palette of the phosphorescent afterglow, however, has been limited to these colors.

Recently, a new group of aluminate based phosphorescent phosphors (e.g. MAl₂O₄:Eu. Dy, M is alkali earth element) that both absorb and emit light in the visible spectrum has become available. Phosphorescent compounds with an aluminate matrix are disclosed in U.S. Pat. Nos. 5,424,006 and 5,686,022. Several follow on patents describes the use of the aluminate phosphors in making plastic composites and articles, which include:

U.S. Pat. No. 5,607,621 describes phosphorescent synthetic resin materials comprising about 5 to about 20% by weight of similar metal aluminates based phosphors and a synthetic resin. Many synthetic resins are mentioned by way of example.

U.S. Pat. No. 5,885,483 describes the compositions and the manufacturing method of long afterglow metal aluminates based phosphors.

U.S. Pat. No. 5,976,411 describes molded, extruded or formed phosphorescent plastic articles made out of a plastic composition comprising a thermoplastic or a thermosetting resin, about 1% to about 50% by weight of phosphorescent pigment and about 0.001% to about 20% by weight of a laser energy absorbing additive.

U.S. Pat. No. 6,093,346 describes the compositions and the manufacturing method of long afterglow metal silicate luminescent materials which main chemical composition formula is: aMO-bM′O-cSiO₂-dR:Euₓ Ln_{y}.

U.S. Pat. No. 6,359,048 describes a luminescent paint by combining alkali earth oxide aluminates phosphors with an alkyd base, a rheology improver, another pigment, an anti-skin additive, and other ingredients, one can achieve a luminescent paint

U.S. Pat. No. 6,375,864 describes compositions and molded, extruded or formed phosphorescent plastic articles comprising aluminates phosphorescent phosphor pigments preferably in combination with polymer-soluble daylight fluorescent dyes.

JP-A-2000-034 414 describes semitransparent light-storing resins, which contain in total 14% by weight of aluminate light storing pigment. Upon incorporation of the pigments of JP-A-2000-034 414 in a polycarbonate resin, the favorable physical properties of the polycarbonate get lost. The aluminates particles are very hard and cause wear of the screws in injection molding machinery. The wear is so strong that graying of the composition processed with the screw may result.

U.S. Pat. Nos. 6,676,852, 6,692,659 and 6,716,368, describe transparent or translucent thermoplastic compositions comprising a thermoplastic (polycarbonate) resin and alkali earth aluminates phosphorescent pigment (phosphor).

The phosphorescent oxide pigments disclosed and used in the current plastic composites are all based on rare earth doped metal (alkali earth) aluminates. There are other phosphorescent materials that can also be effectively applied as the pigment for long afterglow composites or articles. In addition, there are many other forms and uses of phosphorescent blends that will self-glow in darkness without consuming electricity or chemicals.

### SUMMARY OF THE INVENTION

The present invention discloses the use of the pigment of silicates, phosphate, borates, and their compounds with aluminates (e.g. alumino-silicates, alumino-borates, and alumino-phosphate) materials to form self-glowing phosphorescent blends with many utilities. These blends will store energy from solar light, artificial light (i.e. lamps, LED), or lasers, and emit various colors of visible light apparent to naked eye when those excitation light sources are switched off, for hours to days, without consumption of electric energy. Such optical charging and self-glowing process can be repeated for over 1000 times in the ambient temperatures and atmospheres.

In addition, the present invention relates to several forms of the new self-glowing blends. The end products of these blends include self-glowing paints, self-glowing tapes (including pressure sensitive adhesive tape), self-glowing plastic foil, self-glowing glues and sealant, self-glowing writing and printing inks, self-glowing papers and stickers, self-glowing cloth and textiles, self-glowing glass, and self-glowing plastic composites and articles. These articles can store solar, artificial light, or other form of excitation energies, and self-glow multiple colors of visible light apparent to naked eye for hours to days, when those excitation light sources are switched off, without consumption of electric energy. It can be further recharged or re-excited after the self-emitting light fades out. This energy storage-light emitting cycle can go on for years, without electricity consumption. They can be utilized as self-glowing decoration at night, they can also mark objects and directing traffic in the darkness to avoid safety hazard, they can also serve as low light lighting source.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIGS. 1a and 1b illustrate charge-trapping process (FIG. 1a) and thermally activated charge-releasing process (FIG. 1b) through energy level diagrams;

FIG. 2 shows afterglow characteristics of a self-glowing blend with a new pigment (Gd_{0.46}Sr_{0.31})Al_{1.23}OₓF_{1.38}:Eu _{0.04}Dy_{0.02} in 4 different concentrations levels: Sample 1: 80%; Sample 2: 60%; Sample 3: 40%; Sample 4: 20%;

FIG. 3 displays typical excitation and emission spectrums of the self-glowing blend involving (Gd_{0.46}Sr_{0.31})Al_{1.23}OₓF_{1.38}: Eu_{0.04}Dy_{0.02}.

### DETAILED DESCRIPTION OF THE INVENTION

1. The Application of New Phosphorescent Oxide Pigments in the “Self-Glowing” Blends

Although any phosphors with long afterglow can be used as “self-glowing” pigment in the invention, including the long afterglow phosphors, the disclosed self-glowing phosphorescent blends use the following families of phosphor compositions as the new phosphorescent pigments in the blend with many possible forms:

a. Metal Silicates: (M₁₋ₐ,M′ₐ)ₘ(Si_{1-b},Ge_{b})O_{c}:Euₓ Ln_{y}, wherein M is one or multiple alkali earth elements from Be, Mg, Ca, Sr, Ba, and Zn; M′ include at least one elements from the group of Y, La, Sc, B, Al, Ga and P; Ln is one or more of elements from the group of Ce, Pr, Nd, Sm, Gd, Tb, Dy, Ho, Er, Tm, Yb, Pb, Tl, Mn, and Bi; wherein a, b, c, m, x and y are within ranges of 0≦a≦0.9, 0≦b≦0.2, c is the value that depends on the composition of all the metal cations to balance the charge, 0.5≦m≦4, 1×10⁻⁴≦x≦2×10⁻¹, and 1×10⁻⁴≦y≦5×10⁻¹. Such host may also contain a halogen element such as F, Cl, Br or I in an amount within range from 1×10⁻⁵ to 1×10⁻¹ g.atm/mol of the host material.
b. Metal Boro-silicates: Mₐ M′_{b} B_{c} Si O_{d}: Euₓ Ln_{y} (where M is at least one selected from the group consisting alkaline-earth metals including Be, Ba, Sr, Ca, Mg and Zn, M′ is at least one selected from the group consisting Ge, Al, P, Ga, Y, and Sc; Ln is at least one auxiliary activator selected from the group consisting of Nb, Zr, Bi, Mn, Sn, La, Ce, Pr, Nd, Sm, Gd, Tb, Dy, Ho, Er, Tm, Yb, Mn, and Lu wherein a, b, c, d, e, x and y are within ranges of: 0.2≦a≦6, 0≦b≦0.5, 0.001≦c≦0.4, 0.001≦x≦0.3, 0.001≦y≦0.3, d is the value that depends on the composition of all the metal cations to balance the charge,
c. Metal alumino-silicates: Mₐ M′_{b} Al_{c} Si O_{d}: Euₓ Ln_{y}, wherein M represents one or more elements selected from a group consisting of Be, Mg, Sr, Ca, Ba and Zn; M′ represents one ore more elements selected from a group consisting of B, P, Ge, Ga, and Y; Ln represents one or more elements selected from a group consisting of Nd, Dy, Ho, Tm, Pr, Tb, Ce, Mn, and Bi; a, b, c, d, x and y are mole coefficients; wherein 0.2≦a≦8, 0≦b≦5, 0.01≦c≦9, 0.001≦x≦0.4, and 0≦y≦0.4. d is the value that depends on the composition of all the metal cations to balance the charge,
d. Metal Phospho-Silicates: (M₁₋ₐ,M′ₐ)ₘ(Si_{1-b},P_{b})O_{c}: Euₓ Ln_{y}, wherein M represents one or more elements selected from a group consisting of Be, Mg, Sr, Ca, Ba and Zn; M′ represents one ore more elements selected from a group consisting of B, Ge, Al, Ga, Y, La, and Sc; Ln represents one or more elements selected from a group consisting of Nd, Dy, Ho, Tm, La, Pr, Tb, Ce, Mn, Bi, Sn and Sb; a, b, x and y are mole coefficients; wherein 0.4≦a≦8, 0≦b≦6, 0.00001≦x≦0.4, and 0≦y≦0.4; c is the value that depends on the composition of all the metal cations to balance the charge
e. Metal Boro- or Phospho-Aluminates Mₘ M′ₙ AlOₓ: Euₓ Ln_{y}, where, M represents at least one of alkaline earth metal Be, Mg, Sr, Ca, Ba and Zn; M′ represents at least one of a elements of Phosphur (P) or boron (B); Ln is at least one of a rare earth element, 0.5≦m≦08, 0.01≦n≦8, 0.001≦x≦0.4, and 0.001≦y≦0.4.
f. (YₘGd₁₋ₘ)₂OₙS₃₋ₙ: Euₓ Ln_{y}. Ln represents one or more elements selected from a group consisting of Nd, Dy, Ho, Tm, Pr, Tb, Ce, Ti and Bi. 0≦m≦1, 0≦n≦3; 0.001≦x≦0.4, and 0.001≦y≦0.4

The oxide phosphorescent pigments disclosed and used in the current plastic composites are all based on rare earth doped metal oxide (alkali earth) aluminates pigments. Other forms of oxide phosphorescent materials are also identified as potentially efficient phosphorescent materials. Their chemical compositions have been listed in a-f in previous paragraphs. Their application in preparing and the use of the composite or blend in various forms are the basis of this disclosure. Metal silicates, borates, phosphates are effective phosphors hosts, they can also form compound with aluminates to yield effective host for phosphorescent materials. They can form various discrete phases and continuous solid solutions to effectively host the rare earth activators.

Eu²⁺ is a well-known activator cation, it can be excited by long wavelength UV to short wavelength visible light, which induces a 4f-5d parity allowed transition. This range of excitation spectrum overlap well with portions of the solar spectrum, and this series of phosphors can be well excited in the daylight. By systematically varying the elemental compositions, blue to green luminescence can be created from this series of phosphors. Generally, increasing the effective crystal field around the Eu activator will increase its 5d level and induce a shift of both excitation and emission to shorter wavelength. The ionic strength of related cations in these series of phosphors are in the order of Si⁴⁺>Al³⁺>Be²⁺>Mg²⁺>Ca²⁺>Sr²⁺>Ba²⁺. And more ionic strength in the lattice will increase the crystal field around Eu²⁺ and induce a blue shift (e.g. the emission peak of SrAl₂O₄:Eu²⁺ is ˜520 nm compared to ˜540 nm of SrGa₂O₄:Eu²⁺).

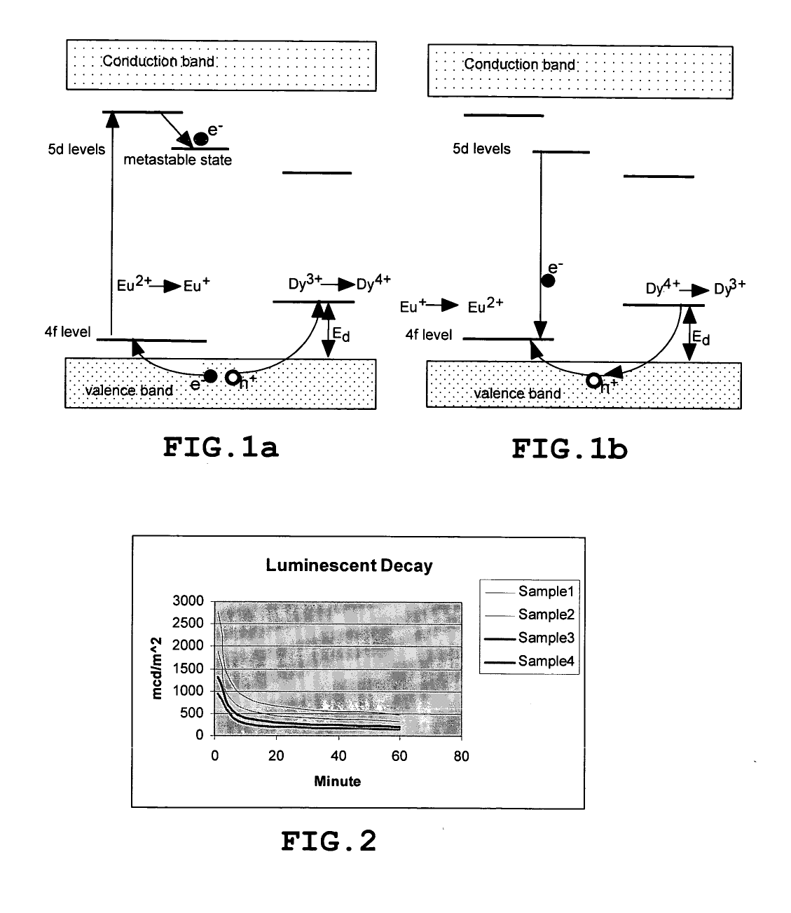

For example, the electronic energy level diagram of the alkali-earth alumino-silicates doped with Eu²⁺ and Dy³⁺ is shown in FIG. 1. The concentration of Eu²⁺ and Dy³⁺ will be limited to percentages level to avoid cross relaxation of their excitation states, which will result in Dy³⁺ emission and destroy the trapping. The following mechanism can be applied for their extremely long afterglow luminescence process:
(a) The charge trapping process: During excitation of an electron from 4f to 5d-state in Eu²⁺, a hole is trapped into Dy³⁺ ground state from valence band, and meanwhile an electron from valence band is filled into the Eu²⁺ 4f-level. This forms a Eu²⁺—Dy⁴⁺ metastable state, the Eu²⁺ emission (5d-4f transition) is delayed (and excitation energy stored) because its 4f-ground state is filled.
(b) Thermally activated charge releasing process: At room temperature, some portion of holes in Dy⁴⁺ will conquer the trapping energy depth (Ed) and recombine with the ground level electron of Eu⁺ via the valence band, which leave the level available for relaxation of Eu⁺ 5d electron. Emission occur of the system is reduced to original Eu²⁺—Dy³⁺ state.

As discussed previously, continuous emission wavelength from blue to green may be generated from the Eu²⁺ activator in this series of energy storage phosphors. However, three primary colors (blue, green and red) are necessary to generate the full color space, including the white color for lighting. Eu²⁺ is not an effective activator for red emission. The following compositions are disclosed for red emission persistent phosphors.

2. Many Forms and Utilities of the Long Afterglow Blends with the New Oxide Phosphorescent Pigments

The following paragraphs disclose concepts and methods of making several specific new products that are self-glowing in the darkness. The self-glowing blends or composites can glow in the darkness without consuming electricity or chemicals; they can be utilized in the following applications with many social benefits:
a) Self-glowing marking, decoration, film coating, and painting on the body of moving vehicles including bicycles, motorcycles, automobiles, ships, and aircrafts. Such utility will display the contour and shape, the location and color of the subject's body at night or in darkness with the benefits of decoration and safety of traveling. Such new “self-glow” vehicles offer ease of vehicle watching and tracking at night without consumption of electricity. The self-glow feature can be applied to the vehicles in the following ways: By applying the self-glowing paints; by printing the self-glowing inks on the vehicle surfaces; by applying self-glowing tapes or films onto the vehicle surface; by directly applying self-glowing plastic composites as structural component of the vehicle body.
b) Self-glowing marking, decoration, film coating, and paintings on the walls, ceilings, swimming pools, stairs, steps, and other outstanding objects inside or outside of a building or park. Beside apparent decoration utility in the darkness, they can show out the contour or locations of the objects in the darkness to avoid injury related liability, without consuming electricity. The self-glow feature can be applied to the target surfaces in the following ways: By applying the self-glowing paints; by printing the self-glowing inks on the target surfaces; by applying self-glowing tapes or films on surface; by directly applying self-glowing plastic composites as the structural component of the targeting objects.
c) Low-level lighting source, i.e. “Electricity less” lamps. By applying the blend of various self-emitting colors (e.g. Red, green blue) according to a certain ratio for a desirable color, on artificial lamp surfaces, they can self-glow in the darkness for hours after lamp is turned off. When lamp is back on, they can be optically excited and charged up, while shifting the lamp color to longer wavelength and warmer color temperature. Such self-glowing features to the lamps will make a new type of “electroless lamp”, whereby low level lighting can be achieved with the same lamp without consumption of electricity.
d) The blends can be utilized in many other special self-glowing products to save electricity and pollution and prevent safety hazards in darkness. For example, self-glowing paper and ink will allow people to write and read in darkness without need for lamps. Self-glowing paint, tapes, ceramic glaze, and labels will allow people to move safely in the darkness. Self-glowing glass and plastic articles will decorate or display at night without need for electric lamps. Besides conserving electricity and environment, self-glowing products may be used to direct traffic and prevent injury when electric lamps failed with power outrage. It also provide convenient safety measures in products such as self-glowing textiles that pedestrian and bicyclists can wear at night, without need for electric lamps. All these new products enabled by the self-glowing pigments are within the scope of the invention.
   3. Examples: Preparation of Stable Self-Glowing Polymer Coating Formula.

As discussed in the introduction, the inorganic phosphorescent pigments must coexist and be compatible in the blend. To maintain the integrity of a polymer coating formula, no detrimental chemical interactions among the components are allowed, those components should stay well mixed without segregation. Finally, one functional component should not shield or degrade the function of other component. The phosphorescent materials can be added as either pigment or extended pigment into some well established polymer coating system, and it also need to follow some criteria for pigments.

To maximize the hiding property of a pigment in the polymer, it needs to have dramatically different refractive index from the surrounding polymers (most polymers have refractive index around 1.5). In addition, more light-scattering results in better hiding property, and particle size similar to the light wavelength afford the highest scattering efficiency. To hide visible light, pigment should be made to be around 0.2 to 1 micron in particle diameter. Finally, extender pigment in the size of 0.2 to 1 micron can be added to ensure the optimum pigment particle separation for maximum scattering.

The phosphors can be ground into fine particles and compounded into polymer system. It can be added as the sole pigment in the paint formula, or as an extender pigment into a pigmented polymer. Due to the higher expense of the phosphors compared to regular pigment, it is more desirable to add a smaller fraction of it as extender with other pigments (e.g. TiO₂, ZnO). Plus, the superior visible light reflectance property of these established white pigments will enhance the visual contrast of the persistent fluorescent emission of the phosphors in the darkness. Finally, these energy storage phosphors have good UV absorption, and they will improve the weatherability of the polymer coating.

The disclosed phosphorescent compositions in a-f should be great extender pigments in polymer coat. For example, alumino-silicate has been widely used as extender pigment, it is actually the only white mineral pigment that is naturally available with particle size below 2 micron. It has good white color, easily dispersible, and extremely inert. In addition, alkali-earth silicates are also well-known extender pigments. For example, the natural Wollastonite (CaSiO₃), which has bright white color and low oil absorption, has been used as extender pigment to increase chemical stability, anticorrosion, and weathering of some polymer coating formula. The natural Talc (Magnesium silicate), is used in a wider variety of polymer coatings than any other single extender, with its superior anti-settling, dispersible properties. Therefore, the proposed energy storage phosphors in series 1, which are solid solutions of aluminum silicate and alkali earth silicates, should also be good extenders.

The refractive index of the disclosed pure oxide phosphors of a-e are around 1.5 to 1.8, which is close to that of the polymers (around 1.5), therefore, they are better used as extender pigments in polymer coat. The refractive index of the rare earth oxosulfides, are expected to be much higher than 1.5 (e.g. the refractive index of Y₂O₃ is around 2, which is close to that of ZnO). Therefore, the oxo-sulfides phosphors can be used as primary pigments. It may also be used as co-pigments with some white pigments such as ZnO or TiO₂ in the polymer coat. Again, rare earth oxosulfides is a series of stable pigments, which is expected to be chemically compatible with polymer coating components.

The following are some formulation examples of the two different types of persistent self-glowing polymer coatings using the disclosed oxide phosphors (a-e) as pigments:

a. Waterborne white gloss persistent growing topcoat

| Materials (brand name) | Function | Parts by weight |
|---|---|---|
| Tioxide RHD2 | TiO2, white pigment | 10 |
| Oxide Phosphors of a-e | Persistent self-glowing ex- | 8.2 |
| | tender | |
| Bisphenol A polymer | Epoxy polymer, binder | 15.7 |
| BYK 034 | Defoamer additive | 0.15 |
| Igepal CO897 | Surfactant, dispersing agent | 0.8 |
| Butyl alcohol | Co-solvent | 1.4 |
| Water | Solvent | 12.9 |
| Hardener: | | |
| Casamide 360 | Fatty polyamide curing | 35.2 |
| | catalysts | |
| Isopropanol | Co-solvent | 4.5 |
| Water | Solvent | 3.0 |

b. Decorative epoxide/polyester persistent glowing powder coating

| Materials (brand name) | Function | Part by weight |
|---|---|---|
| D.E.R. 662UH | Epoxide polymer | 22.3 |
| Uralac P-2230 | Polyester polymer | 36.2 |
| Benzoin | Degasser additive | 0.7 |
| Acrylon MFP | Flow assiting additive | 0.8 |
| Ti-pure R-900 | TiO₂, white pigment | 25 |
| Oxide Phosphors of a-e | Persistednt self-glowing ex- | 15 |
| | tender | |

c. Exterior waterborne white-house persistent glowing coating

| Ingredient/function | Weight (pounds) | gallons |
|---|---|---|
| Water | 234.5 | 28.2 |
| Associative thickener | 19.6 | 2.3 |
| Ammonium hydroxide | 1.8 | 0.2 |
| Mildewcide | 2.0 | 0.2 |
| Dispersant | 6.9 | 0.8 |
| Non-ionic surfactant | 2.1 | 0.3 |
| Propylene glycol/freeze inhibator | 25.9 | 3.0 |
| TiO₂, Rutile/white pigment | 225 | 6.6 |
| Oxide Phosphors of a-e | 210 | 9.4 |

Waterborne polymer formula and powder coat formula are important because of their low VOC and environmental benefit. The brand-named chemicals used in the ingredient are commercially available materials. The persistent phosphor extender (a to e) used here can also be replaced by oxosulfide phosphors (f), or a mixture of the two series of phosphors can be used as extenders, to get some composite long after glowing color, such as white.

The long afterglow phosphors can also be dispersed into other hosts in preparing various objects that store optical energy in daytime or room light and self-glow visible light in darkness. The following will outline the manufacturing formulation and process for several other proposed self-glowing products. Essentially they are all blends or composites of some “binder” matrix with long afterglow phosphors as persistent glowing pigment.

a. Self-Glowing Adhesive Tapes:

Adhesive tape has at least two components: adhesives and backing. The backings include fabric, paper, plastic film, metal foil, foam, etc. The commonly used adhesives include block copolymers, natural rubber, silicone, polyacrylates, polyurethane, butyl rubber and polyisobutylene, other polyolefins, and styrene-butadiene rubber random polymer, etc. To make self-glowing adhesive tape, the persistent phosphor pigments can be compounded with adhesives, providing that the backing is optically transparent. The persistent pigment can also be compounded in the backing materials, or coated on the external side of the backing tape.

b. Self-Glowing Papers, Inks, Clothe and Textures

The long afterglow phosphor particles can also be dispersed and bonded in the hosts and ink solvents, papers, cloth and textures to make them “self-glowing” at night. Standard process in making pigment filled papers, inks, cloth and textures can be applied, by replacing the regular pigments with the long afterglow phosphor particles.

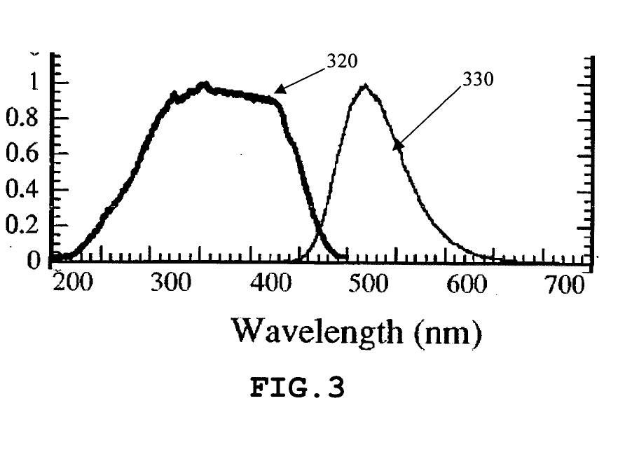

As further example, FIG. 2 shows the luminescent decay characteristic of a blend with an example of the new self-glowing pigment (Gd_{0.46}Sr_{0.31})Al_{1.23}OₓF_{1.38}:Eu_{0.04}Dy_{0.02} at 4 different loading levels (in weight). The blend with other self-glowing pigments in claim 2 through 7 can also be applied with different luminescent decay characters The blend can be any of the previously described paints, coating, films, tapes, paper, textiles, plastics composites, or inks, and the type of different hosts has little effect on the decay. The luminescent self-glow decay can come out from any of the disclosed applications including but not limited to: Self-glowing Vehicles; Self-glowing building and steps; electroless lamp; self-glowing textiles, papers, inks, clothes, books, etc. The excitation and emission spectrum of the self-glowing blends of FIG. 2 are shown in FIG. 3.

It will be apparent to those with ordinary skill of the art that many variations and modifications can be made to the material composition, blend preparation methods, and final forms and uses of the blends disclosed herein without departing form the spirit and scope of the present invention. It is therefore intended that the present invention cover the modifications and variations of this invention provided that they come within the scope of the appended claims and their equivalents, I claim:

1. A phosphorescent blend comprising:
at least one type of persistent self-glowing material emitting in a wavelength range of less than 800 nm and greater than 400 nm with a substantial weight-mixing fraction;
at least one type of highly reflective functional pigment enhancing the effect of the said self-glowing material with a substantial weight-mixing fraction;
at least one type of substrate composite material binding the said blend with a substantial weight-mixing ration.

2. The phosphorescent blend recited in claim 1 wherein the said self-glowing material being Metal Silicates with the general composition of (M₁₋ₐ,M′ₐ)ₘ(Si_{1-b},Ge_{b})O_{c}:Euₓ Ln_{y}, wherein M being one or multiple alkali earth elements from Be, Mg, Ca, Sr, Ba, and Zn; M′ including at least elements from the group of Y, La, Sc, B, Al, Ga and P; Ln being one or more elements from the group of Ce, Pr, Nd, Sm, Gd, Tb, Dy, Ho, Er, Tm, Yb, Pb, Tl, Mn, and Bi; wherein a, b, c, m, x and y being within ranges of 0≦a≦0.9, 0≦b≦0.2, c being the value that depends on the composition of all the metal cations to balance the charge, 0.5≦m≦4, 1×10⁻⁴≦x≦2×10⁻¹, and 1×10⁻⁴≦y≦5×10⁻¹; The self-glowing material may also containing a halogen element such as F, Cl, Br or I in an amount within range from 1×10⁻⁵ to 1×10⁻¹ g.atm/mol of the host material.

3. The phosphorescent blend recited in claim 1 wherein the said self-glowing material being Metal Boro-silicates with the general composition of: Mₐ M′_{b} B_{c} Si O_{d}: Euₓ Ln_{y} (wherein M being at least one selected from the group consisting alkaline-earth metals including Be, Ba, Sr, Ca, Mg and Zn, M′ being at least one selected from the group consisting of Ge, Al, P, Ga, Y, and Sc; Ln being at least one auxiliary activator selected from the group consisting of Nb, Zr, Bi, Mn, Sn, La, Ce, Pr, Nd, Sm, Gd, Tb, Dy, Ho, Er, Tm, Yb, Mn, and Lu wherein a, b, c, d, e, x and y being within ranges of: 0.2≦a≦6, 0≦b≦0.5, 0.001≦c≦0.4, 0.001≦x≦0.3, 0.001≦y≦0.3, d being the value that depends on the composition of all the metal cations to balance the charge,

4. The phosphorescent blend recited in claim 1 wherein the said self-glowing material being Metal alumino-silicates with the general composition of: Mₐ M′_{b} Al_{c} Si O_{d}: Euₓ Ln_{y}, wherein M representing one or more elements selected from a group consisting of Be, Mg, Sr, Ca, Ba and Zn; M′ representing one or more elements selected from a group consisting of B, P, Ge, Ga, and Y; Ln representing one or more elements selected from a group consisting of Nd, Dy, Ho, Tm, Pr, Tb, Ce, Mn, and Bi; a, b, c, d, x and y being mole coefficients; wherein 0.2≦a≦8, 0≦b≦5, 0.01≦c≦9, 0.001≦x≦0.4, and 0≦y≦0.4. d being the value that depends on the composition of all the metal cations to balance the charge,

5. The phosphorescent blend recited in claim 1 wherein the said self-glowing material being Metal Phospho-Silicates with the general composition of (M₁₋ₐ,M′ₐ)ₘ(Si_{1-b},P_{b})O_{c}: Euₓ Ln_{y}, wherein M representing one or more elements selected from a group consisting of Be, Mg, Sr, Ca, Ba and Zn; M′ representing one or more elements selected from a group consisting of B, Ge, Al, Ga, Y, La, and Sc; Ln representing one or more elements selected from a group of Nd, Dy, Ho, Tm, La, Pr, Tb, Ce, Mn, Bi, Sn and Sb; a, b, x and y being mole coefficients; wherein 0.4≦a≦8, 0≦b≦6, 0.00001≦x≦0.4, and 0≦y≦0.4; c being the value that depends on the composition of all the metal cations to balance the charge.

6. The phosphorescent blend recited in claim 1 wherein the said self-glowing material being Metal Boro- or Phospho-Aluminates with the general composition of Mₘ M′ₙ AlOₓ: Euₓ Ln_{y}, where, M representing at least one of alkaline earth metal Be, Mg, Sr, Ca, Ba and Zn; M′ representing at least one of a elements of Phosphur (P) or boron (B); Ln being at least one of a rare earth element, 0.5≦m≦08, 0.01≦n≦8, 0.001≦x≦0.4, and 0.001≦y≦0.4.

7. The phosphorescent blend recited in claim 1 wherein the said self-glowing material being metal oxide phosphor having the general composition of (YₘGd₁₋ₘ)₂OₙS₃₋ₙ: Euₓ Ln_{y}. Ln representing one or more elements selected from a group consisting of Nd, Dy, Ho, Tm, Pr, Tb, Ce, Ti and Bi. 0≦m≦1, 0≦n≦3; 0.001≦x≦0.4, and 0.001≦y≦0.4.

8. The phosphorescent blend recited in claim 1 wherein the said self-glowing material being a mixture of materials recited through claims 2 to 7.

9. The phosphorescent blend recited in claim 8 wherein the said substrate composite material containing at least one of the following organic solvent components: Hydrocarbons, including aliphatic hydrocarbons, aromatic hydrocarbons, chlorinated hydrocarbons, and terpenes; Oxygenated solvents, including ketones, alcohols, glycol ethers, esters, and nitroparaffins; Water or water-borne solvent systems.

10. The phosphorescent blend recited in claim 1 wherein the said self-glowing material having a weight percentage of typically from 1% to 95%, preferably from 10% to 80%.

11. The phosphorescent blend recited in claim 1 wherein the said highly reflective pigment being at least one of the following additives or components: white and color inorganic pigments (e.g. TiO₂, BaSO₄, zinc oxide, iron oxides, molybdate orange, chromium oxide, etc); color organic pigments (e.g. monoarylides, phthalocyanine, etc.); other pigments for UV protection, weatherability, anti-corrosion, fire retardancy, antifouling, thermal/electrical insulating, mildew and bacterial resistance, mar resistance, flooding and floating control.

12. The phosphorescent blend recited in claim 1 wherein the said substrate composite material containing at least one of the following polymer components: Rubber-based binders; Vinyl resins; Acrylic resins; Hydrocarbon Resins and Rituminous binders; Cellulosic resins; Vegetable oils; Alkyd resins; Polyester resins; Formaldehyde resins; Epoxy resins; Polyurethanes; Silicate resins; and Silicone resins.

13. The phosphorescent blend recited in claim 12 wherein the said substrate composite material further containing at least one of the following organic solvent components: Hydrocarbons, including aliphatic hydrocarbons, aromatic hydrocarbons, chlorinated hydrocarbons, and terpenes; Oxygenated solvents, including ketones, alcohols, glycol ethers, esters, and nitroparaffins; Water or water-borne solvent systems.

14. The phosphorescent blend recited in claim 13 wherein the said substrate composite material further containing at least one of the following additives or components:
(i) Prime pigment, including white and color inorganic pigments (e.g. TiO₂, BaSO₄, zinc oxide, iron oxides, molybdate orange, chromium oxide, etc), and color organic pigments (e.g. monoarylides, phthalocyanine, etc.); other pigments for UV protection (weatherability, reflectivity or absorptivity of light and heat, and hiding).
(ii) Extender pigments, including carbonates, sulfates, ocides, silicas, clay, mica silicates (e.g. talc, or magnesium silicate, wollastonite, or calsium silicate, etc.), whose function being to adjust and improve painting properties, such as rheology, durability, film applicability and strength, impermeability, gloss reduction, volume filling for required pigment volume concentration, etc.
(iii) Functional pigments, include corrosion inhibitors, such as lead, zinc, and chromate pigments, borate, phosphate, molybdates, ferrites, etc.; fire retardancy fillers, antifouling, thermal or electrical insulating, mildew and bacterial resistance, mar resistance, flooding and floating control.
(iv) Plasticizers, include monomeric esters of carboxylic and other acids; chlorinated paraffins; linear polyesters, and non-drying fatty oils. Their function being usually to enhanse the flexability and adhesion of paint at the expense of hardness and strength.
(v) Catalysts, which generally enhancing the reactivity of the paint components upon curing. Catalysts including: (a) the dryers for oxidizing systems, such as the molecules of the following metals, cobalt, manganese, lead, zirconium, calcium, barium, zinc, iron, and rare earth metals. (b) Catalysts for non-oxidizing systems such as organic bases, organic acids, and organo-metallic molecules of tin, cobalt, zinc, manganese, zirconium, aluminum, chromium, iron, copper, etc. (c) Initiators, such as peroxides.

15. A self-glowing adhesive tape/film comprising:
a thin substrate of solid or polymeric materials;
a pressure sensitive adhesive coated on at least one side of the said thin substrate;
at least one type of persistent self-glowing material emitting in a wavelength range of less than 800 nm and greater than 400 nm coated on at least one side of the said thin substrate.

16. A self-glowing adhesive tape/film recited in claim 15 wherein the said thin substrate being one of the following materials or their composite: fabric, paper, polymeric film, composite films, laminates, metal foil, foam.

17. A self-glowing adhesive tape/film recited in claim 15 wherein the said pressure sensitive adhesive being solution adhesives or aqueous or hot melt adhesives formed by one of the following materials or their composite: block copolymers, natural rubber, silicone, polyacrylates, polyurethane, butyl rubber and polyisobutylene, other polyolefins, and styrene-butadiene rubber random polymer.

18. A self-glowing solid material comprising:
a solid substrate material that is transparent or semi-transparent to the visible light;
at least one type of persistent self-glowing material emitting in a wavelength range of less than 800 nm and greater than 400 nm blended in the said solid material.

19. A self-glowing solid material recited in claim 18 wherein the said solid substrate including inorganic amorphous transparent material, such as the Borosilicate glass; and polymer materials such as thermoplastic polymers or thermosetting resins. The preferred classes of polymers include thermosets, thermoplastics. Certain polymeric alloys, defined as two or more miscible or partially miscible polymers, and blends, defined as discrete non-miscible phases, are also preferred. Specific examples of thermosets and elastomers include polyurethanes, natural rubber, synthetic rubber, epoxy, phenolic, polyesters, polyamides, and silicones. Specific examples of thermoplastics include polyacetal, polyacrylic, acrylonitrile-butadiene-styrene, polycarbonates, polystyrenes, polyethylene, styrene acrylonitrile, polypropylenes, polyethylene terephthalate, polybutylene terephthalate, nylons (6, 6/6, 6/10, 6/12, 11 or 12), polyamide-imides, polyarylates, polyurethanes, thermoplastic olefins (i.e., polypropylene/impact modifiers such as ethylene, propylene and rubber), elastomers, polyarylsulfone, polyethersulfone, polyphenylene sulfide, polyvinyl chloride, chlorinated polyvinyl chloride, polysulfone, polyetherimide, polytetrafluoro ethylene, fluorinated ethylene propylene, perfluoroalkoxy, polychlorotrifluoro ethylene, ethylene tetrafluoro ethylene, polyvinylidene fluoride, polyvinyl fluoride, polyetherketone, polyether etherketone and polyether ketone ether ketone ketone. Specific examples of alloys and blends include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, thermoplastic elastomer alloys, nylon/elastomers, polyester/elastomers, polyethylene terephthalate/polybutyl terephthalate, acetal/elastomer, styrene-maleic-anhydride/acrylonitrile-butadiene-styrene, polyetherketone/polyethersulfone, polyethylene/nylon and polyethylene/acetal. Specific examples of inorganic polymers include phosphorus based compounds and silicones.

20. Persistent self-glowing fibers, cloth and textiles. Besides containing the disclosed oxide phosphorescent materials of claims 2 to 8 in typically amount of from 1% to 95%; they also contain at least one of the following components: Cotton fibers, silk fibers, animal wool, animal skins, synthetic polymeric fibers such as nylon, and plastic covers.
